(19) United States
(12) Patent Application Publication
(10) Pub. No.: US 2012/0019448 A1
(43) Pub. Date: Jan. 26, 2012

(54) User Interface with Touch Pressure Level Sensing

(75) Inventors: Petri Sakari Pitkanen, Lempaala (FI); Eero IImo Olavi Kukko, Espoo (FI); Gary Wingett, Southampton (GB); Daniel Feng, Basingstoke (GB)

(73) Assignee: Nokia Corporation

(21) Appl. No.: 12/841,265

(22) Filed: Jul. 22, 2010

(51) Int. Cl. G06F 3/041

(52) U.S. Cl. 345/173

(57) ABSTRACT

An apparatus including a housing; electronics in the housing; and a user input configured to allow a user to input information into the apparatus. The user input includes a touch panel on the housing. The user input is connected to the electronics and is configured to distinguish between first and second different levels of touch pressure by a user. The user input is configured to display a keyboard keys graphic. The apparatus is configured such that the first level of touch pressure at a first location of the touch panel is determined to correspond to selecting one of the keys of the graphic by the user as first information. The second level of touch pressure at the first location is determined to correspond to second information which does not correspond to selecting one of the keys of the graphic by the user.

### BACKGROUND OF THE INVENTION

1. Field of the Invention

The invention relates to a user interface and, more particularly, to a user input having touch sensing.

2. Brief Description of Prior Developments

Personal Computing (PC) is moving towards Social Computing (SC). Devices are carried more and more, and the use cases are not always processor dependent. Many tasks can be done with very limited Central Processing Unit (CPU) power if Graphics Processing Unit (GPU) support for media is there. All this leads to the possibility of new innovative computer concepts; one being SmartBooks (ultra light small light powered PCs partly leaning on Cloud services).

A variety of user interface systems and components for mobile devices are known. Virtual key pads, pressure sensing touch pads, and “E INK” displays are known. A localized QWERTY keypad is a popular solution for tasks requiring the user to enter text. On the other hand, touch-based interfaces are becoming increasingly common for many user interface operations that involve e.g. scrolling, zooming, and selection. Touch pads that are capable of sensing different levels of pressure are known. “E INK” is emerging as a display technology that enables low power consumption.

### SUMMARY

The following summary is merely intended to be exemplary. The summary is not intended to limit the scope of the claimed invention.

In accordance with one aspect of the invention, an apparatus is provided including a housing; electronics in the housing; and a user input configured to allow a user to input information into the apparatus. The user input includes a touch panel on the housing. The user input is connected to the electronics and is configured to distinguish between first and second different levels of touch pressure by a user. The user input is configured to display a keyboard keys graphic. The apparatus is configured such that the first level of touch pressure at a first location of the touch panel is determined to correspond to selecting one of the keys of the graphic by the user as first information. The second level of touch pressure at the first location is determined to correspond to second information which does not correspond to selecting one of the keys of the graphic by the user.

In accordance with another aspect of the invention, a user input apparatus is provided comprising a quantum tunneling component (QTC) device; a liquid crystal display located above the QTC device; and a touch panel located above the liquid crystal display. The QTC device is adapted to determined different levels of touch pressure of the user pressing against the touch panel. The display is adapted to display a keyboard keys graphic at the touch panel. The touch panel is adapted to sense location of touch of a finger of the user.

In accordance with another aspect of the invention, a method is provided comprising determining a level of touch pressure by a user on a user input apparatus at a first location, wherein the user input comprises a touch panel; displaying a keyboard keys graphic through the touch panel; when the touch pressure is determined to be a first level, selecting a key indicia of the graphic at the first location as a first user input information; and when the touch pressure is determined to be a second level, using the first location as a different second user input information which does not correspond to selecting one of the keys of the graphic by the user.

In accordance with another aspect of the invention, a program storage device is provided which is readable by a machine, tangibly embodying a program of instructions executable by the machine for performing operations, the operations comprising determining a level of touch pressure by a user on a user input apparatus at a first location, wherein the user input comprises a touch panel; displaying a keyboard keys graphic beneath the touch panel; when the touch pressure is determined to be a first level, selecting a key indicia of the graphic at the first location as a first user input information; and when the touch pressure is determined to be a second level, using the first location as a different second user input information which does not correspond to selecting one of the keys of the graphic by the user.

### BRIEF DESCRIPTION OF THE DRAWINGS

The foregoing aspects and other features of the invention are explained in the following description, taken in connection with the accompanying drawings, wherein:

FIG. 1 is a perspective view of an electronic apparatus incorporating features of the invention;

FIG. 2 is a schematic cross sectional view of a portion of the apparatus shown in FIG. 1 showing components of the user input apparatus;

FIG. 3 is an exploded perspective view of the user input apparatus shown in FIGS. 1 and 2;

FIG. 4 is a block diagram showing some of the components of the apparatus shown in FIG. 1;

FIG. 5 is a perspective view of a portion of the apparatus shown in FIG. 1 with a user's hand interacting with the user input apparatus;

FIG. 6 is a diagram illustrating some steps of a method of the invention;

FIG. 7 is a perspective view of an electronic device in a closed position incorporating features of the invention; and

FIG. 8 is a perspective view of the electronic device shown in FIG. 7 in a fully open position.

### DETAILED DESCRIPTION OF EMBODIMENTS

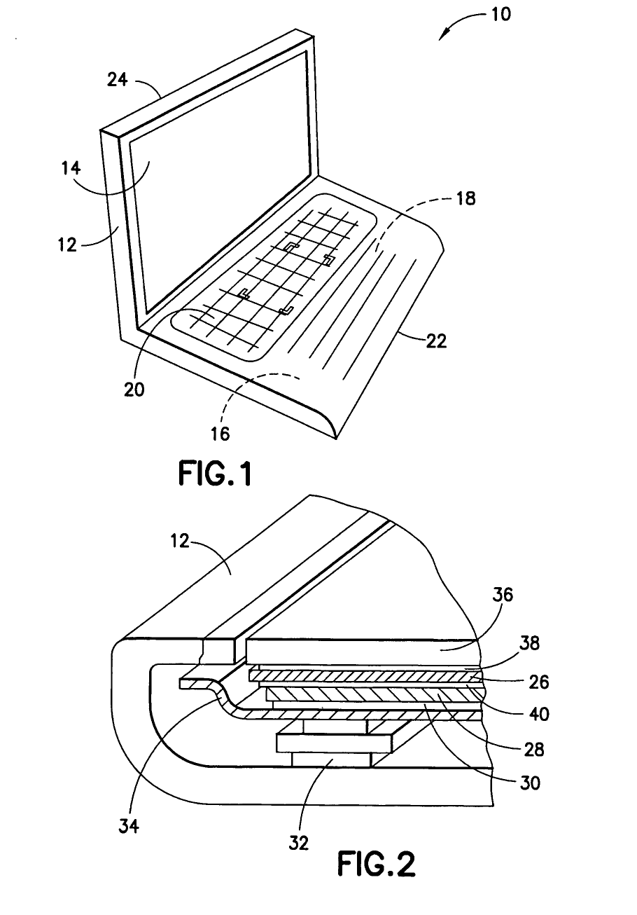

Referring to FIG. 1, there is shown a perspective view of a device or apparatus 10 incorporating features of the invention. Although the invention will be described with reference to the example embodiments shown in the drawings, it should be understood that the invention can be embodied in many alternate forms of embodiments. In addition, any suitable size, shape or type of elements or materials could be used.

In this example embodiment the device 10 is a mobile electronic device such as a laptop computer. However, features of the invention could be used in any suitable type of electronic device having a user input which includes a touch screen type of input system. In this example embodiment the device 10 comprises a housing 12, a display 14, a battery 16, electronics 18 and a user input device or apparatus 20. In an alternate embodiment the user input could be part of the display 14, such as similar to a touch screen. Features of the invention could alternatively be used in a computer monitor which is a touch screen and, thus, does not need the battery for example. As another alternative, features of the invention could be used in a touch screen located in a vehicle, such as an automobile for example. As another alternative, features of the invention could be used in a game controller or media player or other portable hand-held device.

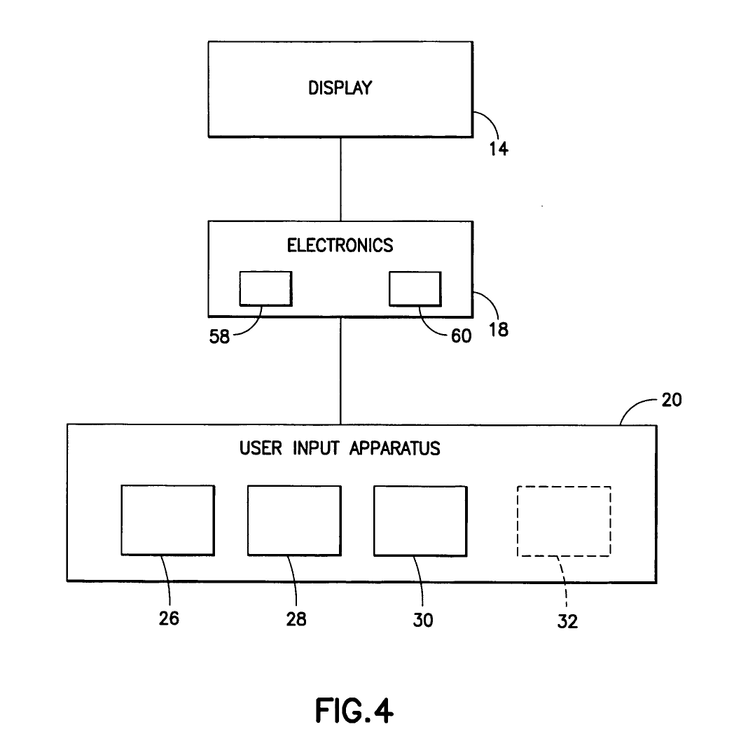

The housing 12, in this example embodiment, has a general clam-shell design with a base 22 and a cover 24 pivotably connected to the base 22. However, in alternate embodiments any suitable housing could be provided. The display 14, such as an LCD display, is on the cover 24. The electronics 18 and battery 16 are located in or on the base 22. The electronics can comprise, for example, printed circuit board(s), processor(s) or controller 58 (see FIG. 4), memory(ies) (see FIG. 4), transceiver(s), and/or other electronic components well known in the portable computer or hand-held electronic device technologies. In this example embodiment the user input apparatus 20 is located on the base 22.

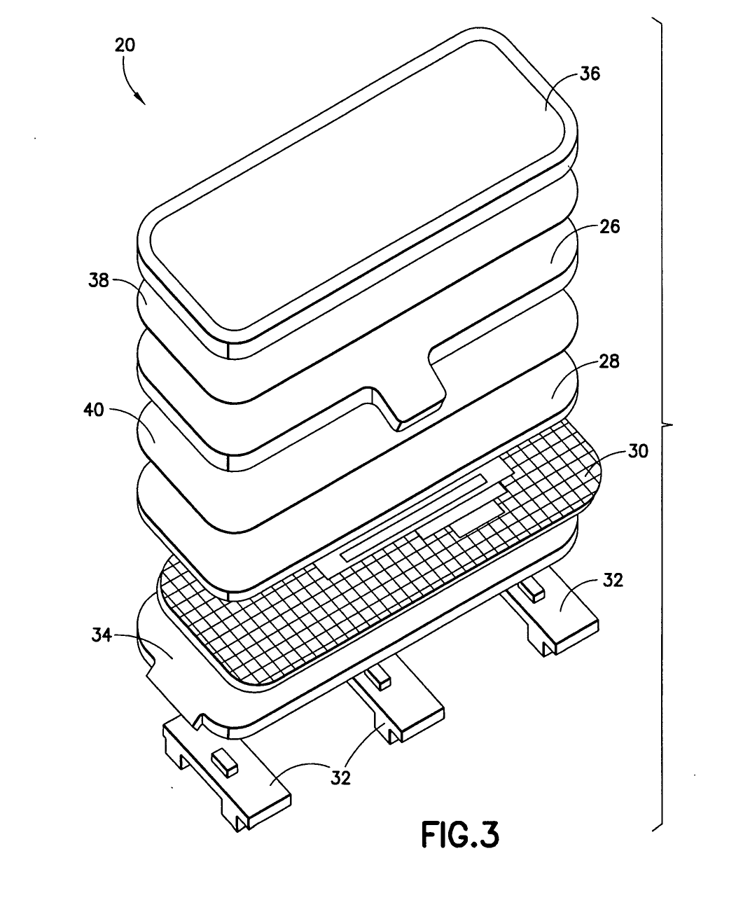

Referring also to FIGS. 2 and 3, the user input apparatus 20 generally comprises a touch panel 26, a display 28 and a pressure level indicator or detector 30. In this embodiment the user input apparatus 20 also includes a haptics or user feedback device 32. In this example embodiment the haptics device 32 are piezoelectric devices. However, in an alternate embodiment the piezoelectric devices might not be provided, or any suitable type of haptics device(s) could be provided. A chassis support 34, such as made of sheet metal for example, can be provided to mechanically support the pressure level indicator 30 to the housing 12. In this example embodiment a conventional touch screen glass-type panel 36 is provided as a top for the input apparatus 20. The touch panel 26 is attached to the bottom side of the top panel 36 by a connection 38, such as an optical clear adhesive for example, to bond the layers in a stack together.

As seen in FIG. 4, the touch panel 26 is operationally connected to the electronics 18. In the example embodiment shown the touch panel 26 could be Indium Tin Oxide on polyester for example, or Indium Tin Oxide on another substrate such as glass for example, to provide a touch panel interface. However, any suitable touch panel structure or configuration could be provided. The display 28 is connected to the bottom side of the touch panel 26 by a connector 40, such as an optical clear adhesive for example, to bond the layers in a stack together.

The display 28, in the example embodiment shown, is preferably a zero-power, bistable display or a Ferro Liquid display. However, any suitable display could be provided. A zenithal bistable device (ZBD) can retain an image without power. The crystals may exist in one of two stable orientations (“Black” and “White”) and power is only required to change the image. There are both grayscale and color ZBD devices. There are also BiNem zero-power, paper-like LCD technology which has been mass-produced since 2007. There are also “no power” display that uses Polymer Stabilized Cholesteric Liquid Crystals (ChLCD). Several bistable technologies, like the 360° BTN and the bistable cholesteric, depend mainly on the bulk properties of the liquid crystal (LC) and use standard strong anchoring, with alignment films and LC mixtures similar to the traditional monostable materials.

In one type of preferred embodiment the display is comprised of “E INK”. “E INK” is a specific proprietary type of electronic paper manufactured by E Ink Corporation. It is commonly used in mobile devices such as e-Readers and to a lesser extent mobile phones and watches. The principal components of “E INK” are millions of tiny microcapsules, about the diameter of a human hair. In one incarnation, each microcapsule contains positively charged white particles and negatively charged black particles suspended in a clear fluid. When a negative electric field is applied, the white particles move to the top of the microcapsule to become visible to the reader. This makes the surface appear white at that location. At the same time, an opposite electric field pulls the black particles to the bottom of the microcapsules where they are hidden. By reversing this process, the black particles appear at the top of the capsule, which now makes the surface appear dark at that location.

In the example embodiment shown the pressure level indicator 30 is located beneath the display 28. As seen in FIG. 4, the pressure level indicator 30 is operationally connected to the electronic circuitry 18 to enable the indicator 30 to send a signal to the electronic circuitry 18. In a preferred embodiment the pressure level indicator 30 comprises a Quantum tunneling composites (QTCs) panel. However, in an alternate embodiment any suitable pressure level indicator could be provided. The indicator 30 can send a signal to the electronics 18 which indicates a level of touch pressure which a user applies to the apparatus 20 when pressing down on the top 36.

Quantum tunneling composites (or QTC) are composite materials of metals and non-conducting elastomeric binder, used as pressure sensors. They utilize quantum tunneling. Without pressure, the conductive elements are too far apart to conduct electricity. When pressure is applied, they move closer and electrons can tunnel through the insulator. The effect is far more pronounced than would be expected from classical (non-quantum) effects alone, as classical electrical resistance is linear (proportional to distance), while quantum tunneling is exponential with decreasing distance, allowing the resistance to change by a factor of up to 1012 between pressured and unpressured states.

QTCs have been implemented within clothing to make “smart”, touchable membrane control panels to control electronic devices within the clothing, e.g. MP3 players or mobile phones. This allows equipment to be operated without removing clothing layers or opening fastenings and makes standard equipment usable in extreme weather or environmental conditions such as Arctic/Antarctic exploration or spacesuits. Due to the low cost of QTC, it is believed that this technology will become more widely available. QTC material is available from PeraTech Ltd. In the example embodiment shown the chassis support 34 can be located beneath the indicator 30 to support the indicator 30 in the housing 12.

In the example embodiment shown the piezoelectric devices 32 are located beneath the chassis support 34 to provide a haptics type of feedback to the user. As indicated in FIG. 4, the piezoelectric devices 32 are connected to the electronics 18 such that a signal can be sent from the electronics 18 to actuate the devices 32. The device 32 can be recessed in separate pockets of the housing 12 if desired. When one of the devices 32 is actuated, a vibration or movement can pass through the stack of components forming the apparatus 20 and be sensed by a user's finger on the top 36. This can be used to signal a user that a predetermined pressure has been applied by the user's finger, or some other event.

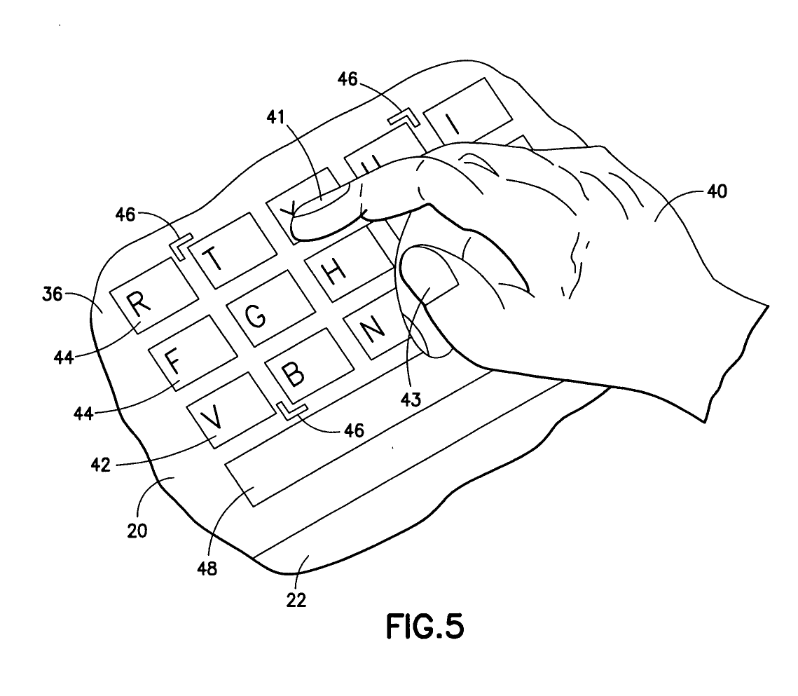

Referring now also to FIG. 5, a partial perspective view of the user input apparatus 20 on the top side of the base 22 of the housing is shown with a user's hand 40. In this example embodiment the display 28 has a keyboard keys graphic or layout image 42 formed by the bistable display. The graphic 42 formed on the display 28 is able to be seen by the user through the layers 36, 38, 26 and 40. FIG. 5 illustrates a standard U.S. type of key layout for the graphic 42. The actual information displayed on the display 28 can be changed or customized by the electronics 18. For example, the electronics 18 could be programmed or configured to display a standard U.K. type of key layout for the graphic 42, or a standard Finnish type of key layout for the graphic 42, or a standard Chinese type of key layout for the graphic 42. These are only some types of examples and should not be considered as limiting. The electronics 18 could be programmed to allow a user to select from the different types of keyboard layouts, or this selection capability could be limited to the manufacturer based upon the expected country of sale for the product 10.

FIG. 5 only partially shows four of the rows of the keys 44 of the keyboard shown on the display 28; some of which are also obscured by the hand 40. A bottom space bar 48, second row including keys V, B, N, M, third row including F, G, H, J, fourth row including R, T, Y, U, I. In this embodiment touchpad brackets 46 are shown by the display 28 at corners of keys T, B, U and M (not shown) to indicate to the user an area of the user input apparatus which can be used as a touchpad. Thus, the input apparatus 20 is designed to function both as a keyboard and as a touchpad; with areas on the top 36 for at least some of the keyboard keys function sharing the same area on the top 36 as the touchpad function. In this example embodiment the area on the top 36 for the user to touch for the touch pad (between the four brackets 46) is the same as the area on the top 36 for the user to touch for the keys T, Y, U, G, H, J, B, N and M. In an alternate embodiment the area for the touchpad function between the four brackets 46 could be larger or smaller, and could include more or less than nine of the keys 44.

In this example embodiment the user input apparatus 20 is configured to operate in two different modes; a first touchpad mode and a second keyboard mode. However, in alternate embodiments more than two modes could be provided. For example additional or alternative modes could include a Chinese character drawing pad mode, and/or a media player control pad mode, and/or a numerical keypad mode. These are only examples and should not be considered as limiting. The same hardware component can be used all over the world in any markets. The area between the brackets 36 can turn into a media player control pad and/or Chinese characters drawing pad. The area between the brackets 36 can work as a sketching pad and/or enables a possibility for a new Application Programming Interface (API) for third parties for any application.

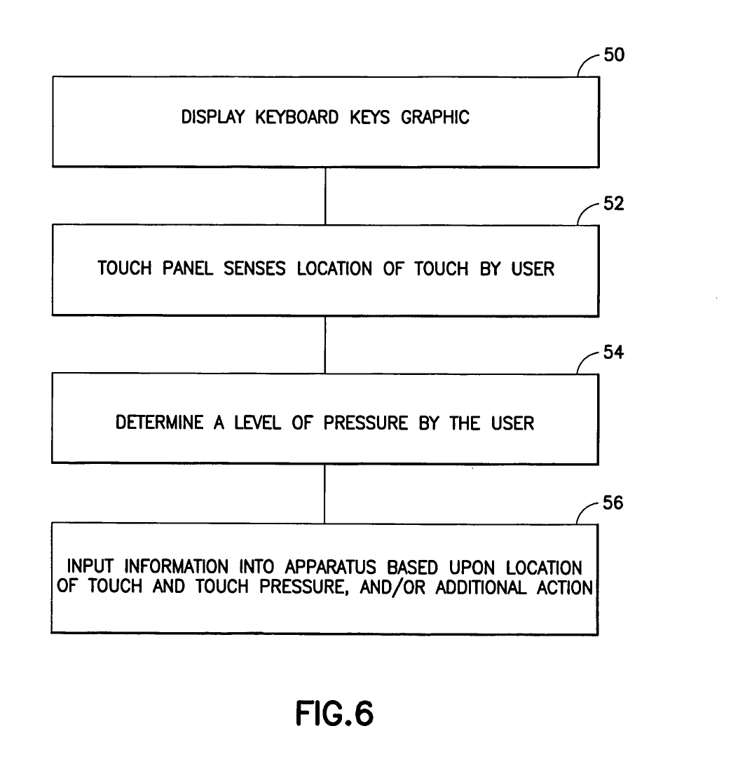

Referring also to FIG. 6, a method of use of the example embodiment can comprise displaying a keyboard keys graphic or layout by the display 28 which can be seen through the touch panel 26 as indicated by block 50. As indicated by block 52, the touch panel 26 can sense the location of touch by user on the top 36, such as by finger 41 shown in FIG. 5. As indicated by block 54, the pressure level indicator 30 can determine a level of touch pressure by the user's finger 41. Based upon 52 and 54, the electronics 18 can be configured, programmed or have software to either function in the first mode as a touchpad between the brackets 46, or function in the second mode as a keyboard. For example, if it is determined that the touch pressure is a lower level of touch pressure, the signal from the finger 41 touching the apparatus 20 can be used by the electronics 18 as a touchpad signal to move a cursor on the display 14 (or any other suitable touchpad type of function). Thus, as indicated by block 56 in FIG. 6, at this lower level of touch pressure, information is input by the user into apparatus 10 based upon location of touch and the fact that the touch pressure is the lower level of touch pressure. An additional action, such as touching the apparatus 20 with another finger (such as with the thumb 43) or at a location outside the brackets 46, could function similar to a right or left mouse button click.

If it is determined that the touch pressure is a higher level of touch pressure, the signal from the finger 41 touching the apparatus 20 can be used by the electronics 18 as a key stroke signal indicating selection of one of the keys 44 by the user. One or more of the haptics devices 32 could be used as a feedback signal to the user that the second mode of operation has occurred and that the apparatus has input the touch as a key stroke. Thus, unlike a conventional laptop computer, with the invention the touchpad function can be located (at least partially) in the same area as a key of the keyboard function. The level of touch pressure can be used to distinguish between the two functions/modes of operation/input.

An an embodiment of the invention can comprise a combination of technologies put together: an “E Ink” display, a QTC 3D pressure sensitive touch layer, and a piezoelectric device for haptics. The result can be an ultra thin customizable haptics keyboard and mouse-type combination that looks stylish and is easy to use. An innovation is putting the two functions, keyboard and mouse, into the same space in a touch screen and, the two functions can be used with same hand(s) at a same time. Replacing the physical keys with haptics and display gives great User eXperience (UX) for keyboard use adding the functionality of the device into the next decade.

In the example embodiment described above, technical implementation is simple. All that is needed are technologies such as an “E Ink” panel, QTC touch layer and Piezoelectrics, along with suitable software or electronics programming. The embodiment can be provided by merely combining all these and replacing the PC keyboard with it. For a manufacturer the same keyboard can be used for all worldwide markets; merely programming or configuring the electronics to display a suitable localize selected keyboard image (such as U.S., British, Finnish, Chinese, etc). The keyboard space can be used for much more than just a keyboard or a mouse-type pointing stick.

One idea is a combined keypad and touchpad, implemented using a combination of an “E Ink” display, and a pressure sensitive touch pad. Pressure level is used to differentiate between whether the user wants to press a key on the virtual keypad, or perform user interface operations on the touch pad. A feature can be using pressure levels to differentiate between pressing a key and using the touch pad.

The image 42 does not have to change while the area between the brackets 36 is being used in a touchpad function. Alternatively, the area between the brackets could change from its normal keyboard keys image to another image, such as for example, when a third higher level of touch pressure causes a signal to be sent to the electronics 18 to change the image at the brackets 36 to a blank area for drawing a Chinese character. As another example, when a third higher level of touch pressure is sensed, the electronics 18 could be programmed to change the display to a media player control pad (such as with play, pause, stop, rewind, fast forward icons) for a predetermined amount of time or perhaps until the third higher level of touch pressure is sensed again. The image 42 does not need to include the brackets 36. Any suitable user signaling by the display 28 of different area(s) for different possible multi-functional (multi-mode) touches could be provided.

It should be noted that the invention is not merely a conventional touch screen function of inputting information based upon location of touch, or duration of touch, or spacing between touches. Instead, an embodiment of the invention can use both conventional touch screen touches (location of touch, or duration of touch, or spacing between touches) and active touch pressure differentiation to input information or a selection into the apparatus. This can be combined with haptics feedback for a user friendly and easy to understand user interface.

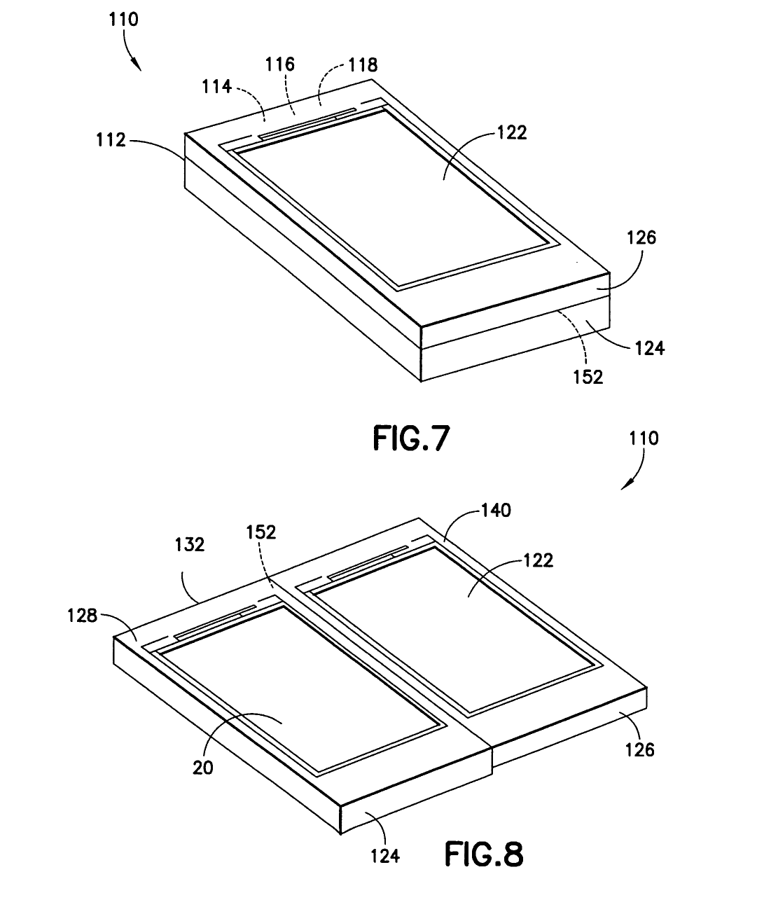

Referring also to FIGS. 7-8, according to another example embodiment of the invention, the device 110 is a multi-function portable electronic device. However, in alternate embodiments, features of the various embodiments of the invention could be used in any suitable type of portable electronic device such as a mobile phone, a gaming device, a music player, a notebook computer, an electronic book reader, or a PDA, for example. The device 110 can include multiple features or applications such as a camera, a music player, a game player, or an Internet browser, for example.

The device 110 generally comprises a housing 112, a transceiver 114 connected to an antenna 116, electronic circuitry 118, such as a controller and a memory for example, within the housing 112, the user input apparatus 20 and a display 122. The display 122 could also form a user input section, such as a touch screen identical to the apparatus 20; except perhaps regarding its bistable graphics or image. The housing 112 comprises a lower housing section 124 and an upper housing section 126. It should be noted that in alternate embodiments, more than two housing sections may be provided. Additionally, in alternate embodiments, the device 110 can have any suitable type of features as known in the art and perhaps only have a single housing section with a single display/input apparatus 20.

The lower housing section 124 and the upper housing section 126 are movably connected to each other. In particular, the upper housing section 126 is movably connected to the lower housing section 124 between a closed position as shown in FIG. 7 and a fully open position as shown in FIG. 8. Another position could include an open relative tilted position (not shown).

The lower housing section 124 comprises an upper face 128. According to the example shown, the lower housing section 124 comprises the user input 20 at the upper face 128. The upper face 128 is substantially covered by the upper housing section 126 when the device 110 is in the closed position. When the device 110 is in the fully open (or fully extended) position, the entire upper face 128 forms a portion (such as about half, or about fifty percent, for example) of the front face of the device 110.

The upper housing section 126 comprises an upper face 140. According to the example, the upper housing section 126 comprises the display 122 (which may be a touch screen display, for example) at the upper face 140. The upper face 140 forms the front face of the device 110 when the device 110 is in the closed position (or closed configuration). The entire upper face 140 forms a portion (such as about half, or about fifty percent, for example) of the front face of the device 110 when the device 10 is in the fully open position (or fully open configuration). The lower housing section 124 and the upper housing section 126 are connected to each other by a connection mechanism 152.

The bistable graphics provided by the input apparatus 20 might not comprise a keyboard keys layout; such as if the apparatus 110 is a portable electronic game. Instead, the graphic or layout might be a game application graphic interface for example. If both components 20 and 122 are the same, than the apparatus 110 could be used for two player use at a same time; one player using component 20 and the other player using component 122. It should be noted again that this is merely an example embodiment. Features of the invention could be used in many different types of electronic devices having a user input.

With one embodiment of the invention, an apparatus 10 can be provided comprising a housing 12; electronics 18 in the housing; and a user input 20 configured to allow a user to input information into the apparatus 10, wherein the user input comprises a touch panel 26 on the housing (such as connected on or in the housing, or being part of the housing, or at least partially integrated to the housing), wherein the user input 20 is connected to the electronics 18 and is configured to distinguish between first and second different levels of touch pressure by a user, wherein the user input is configured to display a keyboard keys graphic 42 with keys 44. The apparatus 10 is configured such that the first level of touch pressure at a first location of the touch panel is determined to correspond to selecting one of the keys 44 of the graphic 42 by the user as first information, and wherein the second level of touch pressure at the first location is determined to correspond to second information which does not correspond to selecting one of the keys of the graphic by the user. The second level of touch pressure can be lower than the first level of touch pressure. The touch panel 26 can comprise Indium Tin Oxide on polyester. The user input 20 can comprise a liquid crystal display 28 as the display panel for displaying the graphic 42, beneath the touch panel 26. The liquid crystal display 28 can be a bistable display. The user input can comprise a pressure level indicator 30 located beneath the liquid crystal display 28. The pressure level indicator 30 can be a quantum tunneling component (QTC) device. The user input 20 can comprise a piezoelectric device 32 located beneath the pressure level indicator 30.

A user input apparatus 20 can be provided comprising a quantum tunneling component (QTC) device 30; a liquid crystal display 28 located above the QTC device 30; and a touch panel 26 located above the liquid crystal display 28. The QTC device 30 is adapted to determined different levels of touch pressure of the user pressing against the touch panel. The display 28 is adapted to display a keyboard keys graphic 42 at the touch panel, and the touch panel is adapted to sense location of touch of a finger 41 of the user. A piezoelectric device 32 can also be provided wherein the quantum tunneling component (QTC) device 30 is located above the piezoelectric device 32, and wherein the piezoelectric device is adapted to provide haptics feedback to a user pressing against the touch panel at the top 36. During a second lower level of the touch pressure, the user input apparatus 20 can be configured to sense touch by another finger 43 of the user and act as a mouse button selector click. The user input apparatus 20 can be configured such that a first level of the touch pressure at a first location of the touch panel is determined to correspond to selecting one of the keys 44 of the graphic 42 by the user as first information, and wherein a second level of touch pressure at the first location is determined to correspond to second information which does not correspond to selecting one of the keys of the graphic by the user.

A method can be provided comprising determining 54 a level of touch pressure by a user on a user input apparatus at a first location, wherein the user input comprises a touch panel; displaying 50 a keyboard keys graphic through the touch panel; when the touch pressure is determined to be a first level, selecting a key indicia of the graphic at the first location as a first user input information; and when the touch pressure is determined to be a second level, using the first location as a different second user input information which does not correspond to selecting one of the keys of the graphic by the user. The second level of touch pressure can be less than the first level of touch pressure. During the second level of the touch pressure, the method can include sensing touch by another finger of the user and thereby sending a signal as a mouse button selector click. When the touch pressure is determined to be the second level, the touch panel can function as a mouse touchpad of an apparatus. When the touch pressure is determined to be the second level, the touch panel can function as media player control pad. When the touch pressure is determined to be the second level, the touch panel can function as Chinese character drawing pad.

With the invention a program storage device readable by a machine, tangibly embodying a program of instructions executable by the machine for performing operations, can be provided such as in the memory 60 or a removable/disconnectable storage device such as a CD-ROM for example, the operations comprising determining a level of touch pressure by a user on a user input apparatus at a first location, wherein the user input comprises a touch panel; displaying a keyboard keys graphic beneath the touch panel; when the touch pressure is determined to be a first level, selecting a key indicia of the graphic at the first location as a first user input information; and when the touch pressure is determined to be a second level, using the first location as a different second user input information which does not correspond to selecting one of the keys of the graphic by the user.

It should be understood that the foregoing description is only illustrative of the invention. Various alternatives and modifications can be devised by those skilled in the art without departing from the invention. For example, features recited in the various dependent claims could be combined with each other in any suitable combination(s). In addition, features from different embodiments described above could be selectively combined into a new embodiment. Accordingly, the invention is intended to embrace all such alternatives, modifications and variances which fall within the scope of the appended claims.

What is claimed is:

1. An apparatus comprising:
a housing;
electronics in the housing; and
a user input configured to allow a user to input information into the apparatus, the user input comprising a touch panel on the housing, the user input being connected to the electronics and configured to distinguish between first and second different levels of touch pressure by a user, the user input being configured to display a keyboard keys graphic,
the apparatus being configured such that the first level of touch pressure at a first location of the touch panel is determined to correspond to selecting one of the keys of the graphic by the user as first information, and being configured such that the second level of touch pressure at the first location is determined to correspond to second information which does not correspond to selecting one of the keys of the graphic by the user.

2. An apparatus as in claim 1 wherein the second level of touch pressure is lower than the first level of touch pressure.

3. An apparatus as in claim 1 wherein the touch panel comprises Indium Tin Oxide on polyester.

4. An apparatus as in claim 1 wherein the user input comprises a liquid crystal display, beneath the touch panel, which is adapted to display the keyboard keys graphic.

5. An apparatus as in claim 4 wherein the liquid crystal display is a bistable display.

6. An apparatus as in claim 4 wherein the user input comprises a pressure level indicator located beneath the liquid crystal display.

7. An apparatus as in claim 6 wherein the pressure level indicator is a quantum tunneling component (QTC) device.

8. An apparatus as in claim 6 wherein the user input comprises a piezoelectric device located beneath the pressure level indicator.

9. An apparatus as in claim 1 wherein the user input comprises a quantum tunneling component (QTC) device.

10. An apparatus as in claim 1 wherein the user input comprises a piezoelectric device.

11. A user input apparatus comprising:
a quantum tunneling component (QTC) device;
a liquid crystal display located above the QTC device; and
a touch panel located above the liquid crystal display,
the QTC device being configured to determine different levels of touch pressure of the user pressing against the touch panel, the display being configured to display a keyboard keys graphic at the touch panel, and the touch panel being configured to sense location of touch of a finger of the user.

12. A user input apparatus as in claim 11 further comprising a piezoelectric device, the quantum tunneling component (QTC) device being located above the piezoelectric device, and the piezoelectric device being configured to provide haptics feedback to a user pressing against the touch panel.

13. A user input apparatus as in claim 11 wherein, during a second lower level of the touch pressure, the user input apparatus is configured to sense touch by another finger of the user and act as a mouse button selector click.

14. A user input apparatus as in claim 11 wherein the user input apparatus is configured such that a first level of the touch pressure at a first location of the touch panel is determined to correspond to selecting one of the keys of the keyboard keys graphic by the user as first information, and configured such that a second level of touch pressure at the first location is determined to correspond to second information which does not correspond to selecting one of the keys of the keyboard keys graphic by the user.

15. A method comprising:
determining a level of touch pressure by a user on a user input apparatus at a first location, the user input comprising a touch panel;
displaying a keyboard keys graphic through the touch panel;
when the touch pressure is determined to be a first level, selecting a key indicia of the graphic at the first location as a first user input information; and
when the touch pressure is determined to be a second level, using the first location as a different second user input information which does not correspond to selecting one of the keys of the graphic by the user.

16. A method as in claim 15 wherein the second level of touch pressure is less than the first level of touch pressure.

17. A method as in claim 15 further comprising, during the second level of the touch pressure, sensing touch by another finger of the user and thereby sending a signal as a mouse button selector click.

18. A method as in claim 15 wherein, when the touch pressure is determined to be the second level, the touch panel functioning as a mouse touchpad of an apparatus.

19. A method as in claim 15 wherein, when the touch pressure is determined to be the second level, the touch panel functioning as media player control pad.

20. A method as in claim 15 wherein, when the touch pressure is determined to be the second level, the touch panel functioning as Chinese character drawing pad.

21. A program storage device readable by a machine, tangibly embodying a program of instructions executable by the machine for performing operations, the operations comprising:
determining a level of touch pressure by a user on a user input apparatus at a first location, the user input comprising a touch panel;
displaying a keyboard keys graphic beneath the touch panel;
when the touch pressure is determined to be a first level, selecting a key indicia of the graphic at the first location as a first user input information; and
when the touch pressure is determined to be a second level, using the first location as a different second user input information which does not correspond to selecting one of the keys of the graphic by the user.
